(19) United States
(12) Patent Application Publication
(10) Pub. No.: US 2026/0027462 A1
(43) Pub. Date: Jan. 29, 2026

(54) VIRTUAL PROP RECOMMENDATION

(71) Applicant: Tencent Technology (Shenzhen) Company Limited, Shenzhen (CN)

(72) Inventors: Jialu ZHANG, Shenzhen (CN); Xin CHEN, Shenzhen (CN); Yuntao PENG, Shenzhen (CN); Jun ZHANG, Shenzhen (CN); Gen LI, Shenzhen (CN); Xiaolong HUAI, Shenzhen (CN); Mingyang WU, Shenzhen (CN)

(73) Assignee: Tencent Technology (Shenzhen) Company Limited, Shenzhen (CN)

(21) Appl. No.: 19/344,081

(22) Filed: Sep. 29, 2025

Related U.S. Application Data
(63) Continuation of application No. PCT/CN2024/118012, filed on Sep. 10, 2024.

(30) Foreign Application Priority Data
Nov. 28, 2023 (CN) 202311613125.7

(51) Int. Cl. A63F 13/533; A63F 13/798

(52) U.S. Cl. CPC A63F 13/533; A63F 13/798

(57) ABSTRACT

In a method for recommending virtual items, based on a selection of a target virtual character, item recommendation information matching the target virtual character is obtained. The target virtual character is configured to perform a virtual task. The item recommendation information includes a first item set. Item preselection information of a target account is obtained. The item preselection information includes a second item set preconfigured by the target account. Based on a set difference between the first item set and the second item set, a recommendation interface including set identifier information is output for display. In the recommendation interface, an item identifier corresponding to at least one virtual item is output for display. Based on a target operation performed on the recommendation interface, an update indication is output for display. The update indication indicates that the item preselection information is updated based on the first item set.

### RELATED APPLICATIONS

The present application is a continuation of International Application No. PCT/CN2024/118012, filed on Sep. 10, 2024, which claims priority to Chinese Patent Application No. 202311613125.7, filed on Nov. 28, 2023. The entire disclosures of the prior applications are hereby incorporated by reference.

### FIELD OF THE TECHNOLOGY

The application relates to the field of computer technologies, including a virtual prop recommendation method.

### BACKGROUND OF THE DISCLOSURE

In a game application of a confrontation type, a player may predetermine an equipment outfit before a game starts, and then a strong prompt is provided for a to-be-obtained virtual prop in a game process by using the preselected equipment outfit, to instruct the player to obtain a corresponding virtual prop to participate in a game task.

The player usually habitually selects a historically used equipment outfit, but the equipment outfit habitually used by the player is not necessarily an equipment outfit most suitable for a current game task. However, the player usually finds that the current outfit is not suitable for the current game task only when the player uses the current outfit to virtually confront and confrontation fails, and further considers adjusting the preselected equipment outfit. In other words, a virtual prop preselection method in related technology has technical problems of low selection accuracy and low efficiency. In addition, the player frequently selects and replaces a virtual prop, increasing a data transmission amount between a game application client and a server, increasing occupied bandwidth of a network. In addition, the server needs to load and release the virtual prop based on virtual prop switching, increasing resource consumption of the server.

For the foregoing problems, no effective solution has been provided yet currently.

### SUMMARY

Aspects of this disclosure provide a virtual prop recommendation method, a virtual prop recommendation apparatus, and a non-transitory computer-readable storage medium, to improve selection efficiency of a virtual prop. Examples of technical solutions of this disclosure may be implemented as follows:

An aspect of this disclosure provides a method for recommending virtual items. In the method, based on a selection of a target virtual character from a plurality of candidate virtual characters, item recommendation information matching the target virtual character is obtained. The target virtual character is configured to perform a virtual task. The item recommendation information includes a first item set. Item preselection information of a target account for the target virtual character is obtained. The item preselection information includes a second item set preconfigured by the target account for the target virtual character. Based on a set difference between the first item set and the second item set satisfying an item recommendation condition, a recommendation interface including set identifier information is output for display. In the recommendation interface, an item identifier corresponding to at least one virtual item included in the first item set is output for display. Based on a target operation performed on the recommendation interface, an update indication is output for display. The update indication indicates that the item preselection information is updated based on the first item set.

An aspect of this disclosure provides an apparatus for recommending virtual items. The apparatus includes processing circuitry configured to obtain, based on a selection of a target virtual character from a plurality of candidate virtual characters, item recommendation information matching the target virtual character. The target virtual character is configured to perform a virtual task. The item recommendation information includes a first item set. The processing circuitry is configured to obtain item preselection information of a target account for the target virtual character. The item preselection information includes a second item set preconfigured by the target account for the target virtual character. The processing circuitry is configured to output for display, based on a set difference between the first item set and the second item set satisfying an item recommendation condition, a recommendation interface including set identifier information. The processing circuitry is configured to output for display, in the recommendation interface, an item identifier corresponding to at least one virtual item included in the first item set. The processing circuitry is configured to output for display, based on a target operation performed on the recommendation interface, an update indication. The update indication indicates that the item preselection information is updated based on the first item set.

An aspect of this disclosure provides a virtual prop recommendation method, applied to an electronic device, and including: obtaining, in response to selecting a target virtual character from a plurality of candidate virtual characters, prop recommendation information matching the target virtual character, the target virtual character being configured for executing a virtual confrontation task, and the prop recommendation information including a first prop set; obtaining prop preselection information configured by a target account for the target virtual character, the prop preselection information including a second prop set preconfigured by the target account for the target virtual character; displaying a prop recommendation interface when a set difference between the first prop set and the second prop set meets a prop recommendation condition, and displaying, in the prop recommendation interface, a prop identifier corresponding to at least one virtual prop included in the first prop set; and displaying, in response to a target operation for the prop recommendation interface, update prompt information, the update prompt information being configured for indicating that the prop preselection information has been updated based on the first prop set.

An aspect of this disclosure provides a virtual prop recommendation apparatus, including: a first obtaining unit, configured to obtain, in response to selecting a target virtual character from a plurality of candidate virtual characters, prop recommendation information matching the target virtual character, the target virtual character being configured for executing a virtual confrontation task, and the prop recommendation information including a first prop set; a second obtaining unit, configured to obtain prop preselection information configured by a target account for the target virtual character, the prop preselection information including a second prop set preconfigured by the target account for the target virtual character; a first display unit, configured to display a prop recommendation interface when a set difference between the first prop set and the second prop set meets a prop recommendation condition, and display, in the prop recommendation interface, a prop identifier corresponding to at least one virtual prop included in the first prop set; and a second display unit, configured to display, in response to a target operation for the prop recommendation interface, update prompt information, the update prompt information being configured for indicating that the prop preselection information has been updated based on the first prop set.

In some aspects, the first display unit includes: an obtaining module, configured to obtain recommendation description information included in the prop recommendation information, the recommendation description information being configured for indicating a set feature of the first prop set; and a display module, configured to display the recommendation description information in a display area associated with the prop recommendation interface.

In some aspects, the display module is configured to at least one of the following: display set identifier information of the first prop set in the display area associated with the prop recommendation interface, the set identifier information being configured for indicating a confrontation feature of the first prop set in the virtual confrontation task; display a target virtual path matching the first prop set in the display area associated with the prop recommendation interface, the target virtual path being a virtual travel path of the target virtual character in a process of completing the virtual confrontation task; and display a set recommendation reason of the first prop set in the display area associated with the prop recommendation interface, the set recommendation reason being configured for indicating a comparison result of the first prop set and the second prop set.

In some aspects, the second display unit is configured to at least one of the following: highlight the set identifier information in the recommendation description information based on a target animation; decorate and display the target virtual character displayed in the current interface based on the at least one virtual prop included in the first prop set; and display an update prompt interface, and display update prompt text in the update prompt interface, the update prompt text being configured for indicating that the prop preselection information has been updated based on the first prop set.

In some aspects, the second obtaining unit is further configured to at least one of the following: determine, when a quantity of virtual props included in a difference set of the first prop set and the second prop set is greater than or equal to a target quantity, that the set difference between the first prop set and the second prop set meets the prop recommendation condition; determine, when a first win rate parameter corresponding to the first prop set is greater than a second win rate parameter corresponding to the second prop set, that the set difference between the first prop set and the second prop set meets the prop recommendation condition; and determine, when a first confrontation parameter corresponding to the first prop set is greater than a second confrontation parameter corresponding to the second prop set, that the set difference between the first prop set and the second prop set meets the prop recommendation condition, the first confrontation parameter being configured for indicating confrontation strength possessed by the target virtual character equipped with a virtual prop in the first prop set, and the second confrontation parameter being configured for indicating confrontation strength possessed by the target virtual character equipped with a virtual prop in the second prop set.

In some aspects, the first display unit is further configured to: display, in response to a trigger operation for the prop identifier displayed in the prop recommendation interface, prop description information of the virtual prop corresponding to the prop identifier.

In some aspects, the first display unit is further configured to: determine a target virtual prop based on the first prop set and the second prop set, the target virtual prop being a virtual prop that belongs to the first prop set but not to the second prop set; and highlight a target prop identifier of the target virtual prop.

In some aspects, the virtual prop recommendation apparatus is further configured to at least one of the following: cancel, in response to a touch operation for a cancel control in the prop recommendation interface, display of the prop recommendation interface; and cancel display of the prop recommendation interface when a display duration of the prop recommendation interface is greater than or equal to a target duration.

In some aspects, the virtual prop recommendation apparatus further includes at least one of the following: a third display unit, configured to obtain, in response to a sliding operation for the prop recommendation interface, first reference recommendation information matching the target virtual character, the first reference recommendation information including a third prop set; a fourth display unit, configured to display, in the prop recommendation interface, a prop identifier corresponding to at least one virtual prop included in the third prop set; obtain, in response to switching the target virtual character to a first virtual character, second reference recommendation information matching the first virtual character, the second reference recommendation information including a fourth prop set; and obtain a fifth prop set preconfigured by the target account for the first virtual character; and a fifth display unit, configured to display, in the prop recommendation interface when a set difference between the fourth prop set and the fifth prop set meets the prop recommendation condition, a prop identifier corresponding to at least one virtual prop included in the fourth prop set; obtain, in response to switching a first virtual path of the target virtual character to a second virtual path, third reference recommendation information matching the second virtual path, the third reference recommendation information including a sixth prop set; and display, in the prop recommendation interface, a prop identifier corresponding to at least one virtual prop included in the sixth prop set.

In some aspects, the first obtaining unit includes: a first obtaining module, configured to obtain a plurality of pieces of fourth reference recommendation information matching the target virtual character, the fourth reference recommendation information including a seventh prop set; and determine the prop recommendation information from the plurality of pieces of fourth reference recommendation information based on a win rate parameter corresponding to each seventh prop set; a second obtaining module, configured to obtain the prop recommendation information pushed by a teammate account, the teammate account being an object account having a same confrontational camp as the target account; and a third obtaining module, configured to obtain a historical operation record of the target account, the historical operation record including operation parameters of a plurality of virtual confrontation tasks completed by the target account controlling the target virtual character; and determine the prop recommendation information based on the operation parameters respectively corresponding to the plurality of virtual confrontation tasks.

In some aspects, the first obtaining module is configured to: obtain a first character identifier of a teammate virtual character selected by the teammate account and a second character identifier of an opponent virtual character selected by an opponent account; determine a virtual character combination corresponding to the virtual confrontation task based on the first character identifier and the second character identifier; and determine the win rate parameter corresponding to each seventh prop set based on the virtual character combination.

In some aspects, the second obtaining module is further configured to: obtain, in response to a selection operation for an account identifier of a target teammate account in at least one teammate account, a teammate virtual character selected by the target teammate account; and push, in response to selecting target prop recommendation information from a plurality of pieces of prop recommendation information matching the teammate virtual character, the target prop recommendation information to the target teammate account.

In some aspects, the virtual prop recommendation apparatus is further configured to: obtain, in a process of completing the virtual confrontation task based on the first prop set by the target virtual character and in response to a current confrontation parameter meeting a prop adjustment condition, prop adjustment information matching the current confrontation parameter, the prop adjustment information including an eighth prop set; display, in an application interface based on the prop adjustment information, a prop identifier of at least one virtual prop included in the eighth prop set; and update, in response to a selection operation for the prop adjustment information, the first prop set to the eighth prop set.

An aspect of this disclosure provides a non-transitory computer-readable storage medium storing instructions which, when executed by a processor, cause the processor to implement any of the foregoing virtual prop recommendation methods.

An aspect of this disclosure provides a computer program product. The computer program product includes a computer program/instructions. The computer instructions are stored in a computer-readable storage medium. A processor of a computer device reads the computer program/instructions from the computer-readable storage medium. The processor executes the computer program/instructions, to cause the computer device to perform any of the foregoing virtual prop recommendation methods.

An aspect of this disclosure provides an electronic device, including a memory and a processor. The memory has a computer program stored therein. The processor is configured to perform any of the foregoing virtual prop recommendation methods by using the computer program.

In aspects of this disclosure, the prop recommendation information matching the target virtual character is obtained in response to selecting the target virtual character from the plurality of candidate virtual characters, the prop recommendation information including the first prop set; the prop preselection information configured by the target account for the target virtual character is obtained, the prop preselection information including the second prop set preconfigured by the target account for the target virtual character; when the set difference between the first prop set and the second prop set meets the prop recommendation condition, the prop recommendation interface is displayed and the prop identifier corresponding to at least one virtual prop included in the first prop set is displayed in the prop recommendation interface; and the update prompt information is displayed in response to the target operation for the prop recommendation interface, thereby achieving strong reminding of a better prop set in an interface in a process of preselecting a prop set, implementing quick switching of a preselected prop set in response to a one-click/tap operation on strong reminding information, reducing operation complexity of selecting a virtual prop, improving accuracy and efficiency of selecting a virtual prop, reducing a data transmission amount, improving network bandwidth utilization, and reducing resource consumption of a server.

### BRIEF DESCRIPTION OF THE DRAWINGS

FIG. 1 is a schematic diagram of a hardware environment of a virtual prop recommendation method according to an aspect of this disclosure.

FIG. 2 is a schematic flowchart of a first implementation of a virtual prop recommendation method according to an aspect of this disclosure.

FIG. 3 is a flowchart of a second implementation of a virtual prop recommendation method according to an aspect of this disclosure.

FIG. 4 is a schematic flowchart of a third implementation of a virtual prop recommendation method according to an aspect of this disclosure.

FIG. 5 is a schematic flowchart of a fourth implementation of a virtual prop recommendation method according to an aspect of this disclosure.

FIG. 6 is a schematic flowchart of a fifth implementation of a virtual prop recommendation method according to an aspect of this disclosure.

FIG. 7 is a flowchart of a sixth implementation procedure of a virtual prop recommendation method according to an aspect of this disclosure.

FIG. 8 is a schematic flowchart of a seventh implementation of a virtual prop recommendation method according to an aspect of this disclosure.

FIG. 9 is a schematic diagram of a structure of a virtual prop recommendation apparatus according to an aspect of this disclosure.

FIG. 10 is a schematic diagram of a structure of an electronic device according to an aspect of this disclosure.

### DETAILED DESCRIPTION

To understand the solutions of this disclosure, the following describes technical solutions in aspects of this disclosure with reference to the accompanying drawings. The described aspects are some of the aspects of this disclosure rather than all of the aspects. Other aspects shall fall within the scope of this disclosure. Further, the descriptions of the terms are provided as examples and are not intended to limit the scope of the disclosure.

In this specification, claims, and the accompanying drawings of this disclosure, the terms “first”, “second”, and the like are intended to distinguish similar objects but do not necessarily indicate a specific order or sequence. Such used data is interchangeable where appropriate so that the aspects of this disclosure described here can be implemented in an order other than those illustrated or described here. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

Terms involved in this disclosure are explained below.
(1) Multiplayer online battle arena (MOBA) game: In this type of game, a player may obtain a virtual prop in a virtual confrontation process, where players are usually divided into two teams, and the two teams compete for confrontation with each other in a dispersed virtual map.
(2) A character selection stage is a stage in which in the MOBA game, a player selects a virtual character to be used in this battle, and includes a hero forbidden stage and a hero selection stage.
(3) A hero outfit includes decision-making solutions such as a combination solution of virtual equipment and a combination solution of virtual skills, may be selected before a battle starts, and may be used in the battle, to reduce decision-making operations related to prop selection and skill selection in a confrontation process, thereby improving decision-making efficiency.
(4) A virtual prop is a fictional object designed in a game, and may be a tool, equipment, a consumable, or a task object used by a character.
(5) A virtual character may refer to a fictional character that is designed in a game and that has a particular appearance, personality, capability, and background story. These characters may be protagonists controlled by a player, or may be non-player characters in a game world.
(6) A prompt bubble may also refer to a tooltip, is a user interface (UI) element, and is configured for providing additional information or descriptions when a user interacts with an interface.

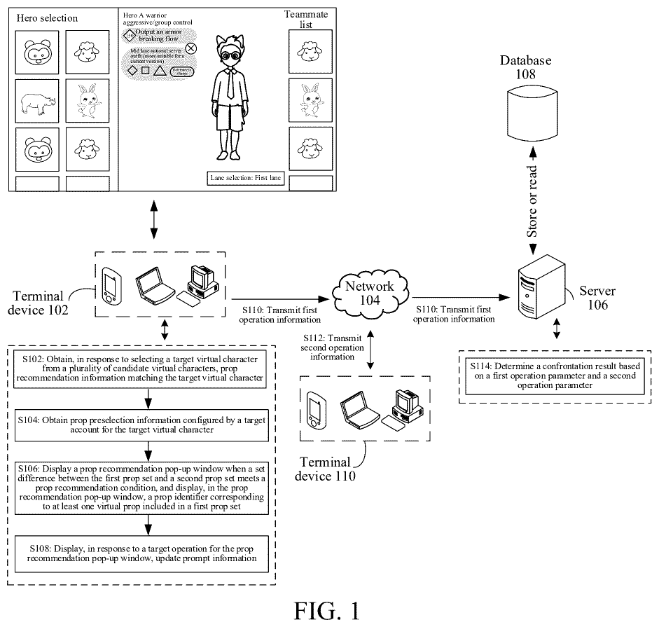

An aspect of this disclosure provides a virtual prop recommendation method. The virtual prop recommendation method may be applied to, and is not limited to being applied to, a virtual prop recommendation system in the hardware environment shown in FIG. 1. The virtual prop recommendation system may include, and is not limited to, a terminal device 102, a network 104, a server 106, a database 108, and a terminal device 110. A target client runs in the terminal device 102 and the terminal device 110 separately (as shown in FIG. 1, an example in which the target client is a game application client is used). The terminal device 102 and the terminal device 110 separately include a human-computer interaction screen, a processor, and a memory. The human-computer interaction screen is configured for displaying a virtual game scene (the virtual game scene shown in FIG. 1), and is further configured for providing a human-computer interaction interface to receive a human-computer interaction operation for controlling a virtual character controlled in a virtual scene, where the virtual character completes a game task in the virtual scene. The processor is configured to generate an interaction instruction in response to the human-computer interaction operation, and transmit the interaction instruction to the server. The memory is configured to store related attribute data, such as object attribute information of the controlled virtual character and attribute information of a held virtual prop. The attribute information herein may include, and is not limited to, information for identifying an identity and a current position of the virtual character. A client on which a target account is logged into and a target virtual character is controlled by using the target account runs on the terminal device 102. In some aspects, when a reference virtual character is a virtual character controlled by the terminal device, a client on which the reference virtual character is controlled runs on the terminal device 110. The target virtual character and the reference virtual character herein may be controlled to perform a particular interaction event in a game, for example, an attack event, a defense event, or a skill cast event.

Furthermore, the server 106 includes a processing engine. The processing engine is configured to perform a storing or reading operation on the database 108. In some aspects, the processing engine reads, from the database 108, virtual object information of each virtual character and information about an operation executed by the virtual character.

It is assumed that the terminal device 102 in FIG. 1 is configured to control a target virtual character, and the terminal device 110 is configured to control a reference virtual character in a same game task. In some aspects, the target virtual character is controlled by using the following operations: Operations S102 to S108 are as follows: obtain, in response to selecting a target virtual character from a plurality of candidate virtual characters, prop recommendation information matching the target virtual character, the target virtual character being configured for executing a virtual confrontation task, and the prop recommendation information including a first prop set; obtain prop preselection information configured by a target account for the target virtual character, the prop preselection information including a second prop set preconfigured by the target account for the target virtual character; display a prop recommendation interface when a set difference between the first prop set and the second prop set meets a prop recommendation condition, and display, in the prop recommendation interface, a prop identifier corresponding to at least one virtual prop included in the first prop set; and display, in response to a target operation for the prop recommendation interface, update prompt information, the update prompt information being configured for indicating that the prop preselection information has been updated based on the first prop set.

Next, operation S110 and operation S112 are as follows: The terminal device 102 transmits first operation information to the server 106 via the network 104. The terminal device 110 transmits second operation information to the server 106 via the network 104. The first operation parameter and the second operation parameter are separately configured for controlling a virtual character in the virtual scene. Next, S114 is performed in the server 106: Determine a confrontation result based on the first operation parameter and the second operation parameter.

In some aspects, when a CPU speed of the terminal device 102 or the terminal device 110 is greater than a specific speed threshold and a quantity of CPU cores is greater than a first quantity threshold, it can be considered that the terminal device 102 or the terminal device 110 has a powerful computing processing capability, and the foregoing operation S114 may alternatively be completed by the terminal device 102 or the terminal device 110. This is merely an example herein. This is not limited in any way in aspects of this disclosure.

In some aspects, the foregoing terminal device may be a terminal device configured with a target client, and may include, and is not limited to, at least one of the following: a mobile phone (such as an Android mobile phone or an iOS mobile phone), a notebook computer, a tablet computer, a palmtop computer, a mobile internet device (MID), a PAD, a desktop computer, a smart television, or the like. The target client may be a client that supports providing a shooting game task, for example, a video client, an instant messaging client, a browser client, or an education client. The network may include, and is not limited to, a wired network and a wireless network. The wired network includes a local area network, a metropolitan area network, and a wide area network. The wireless network includes Bluetooth, Wi-Fi, and another network implementing wireless communication. The foregoing server may be a signal server, a server cluster including a plurality of servers, or a cloud server. The foregoing descriptions are merely an example. This is not limited in any way in aspects of this disclosure.

In some aspects, the foregoing virtual character control method may be applied to, and is not limited to being applied to, a gaming terminal application (APP) for completing a given confrontational game task in the virtual scene, for example, a virtual confrontational game application in a multiplayer online battle arena (MOBA) application. The confrontational game task may be, and is not limited to being applied to, a game task completed through confrontational interaction between a virtual character controlled by a current player through virtual character human-computer interaction in the virtual scene and a virtual character controlled by another player. The foregoing virtual character control method may further be applied to a terminal application of a multiplayer online role-playing game (MMORPG) type. In this type of game, the current player may complete a social game task in the game in a role-playing manner and at a first viewing angle of a virtual character, for example, complete a game task together with another virtual character. The social game task herein may be, and is not limited to, running in an application (for example, a game APP not running independently) in a form of a plug-in or a mini program, or running in an application (for example, a game APP running independently) in a game engine. The type of the foregoing game application may include, and is not limited to, at least one of the following: a two dimension (2D) game application, a three dimension (3D) game application, a virtual reality (VR) game application, an augmented reality (AR) game application, and a mixed reality (MR) game application. The foregoing descriptions are merely an example. This is not limited in any way in aspects of this disclosure.

In this aspect of this disclosure, prop recommendation information matching the target virtual character is obtained in response to selecting a target virtual character from a plurality of candidate virtual characters, the prop recommendation information including a first prop set; when a set difference between the first prop set and the second prop set meets a prop recommendation condition, prop preselection information configured by a target account for the target virtual character is obtained, the prop preselection information including a second prop set preconfigured by the target account for the target virtual character; a prop recommendation interface is displayed and a prop identifier corresponding to at least one virtual prop included in the first prop set is displayed in the prop recommendation interface; and update prompt information is displayed in response to a target operation for the prop recommendation interface, thereby achieving strong reminding of a better prop set in an interface in a process of preselecting a prop set, implementing quick switching of a preselected prop set in response to a one-click/tap operation on strong reminding information, and resolving a technical problem of low selection efficiency of a related virtual prop preselection method.

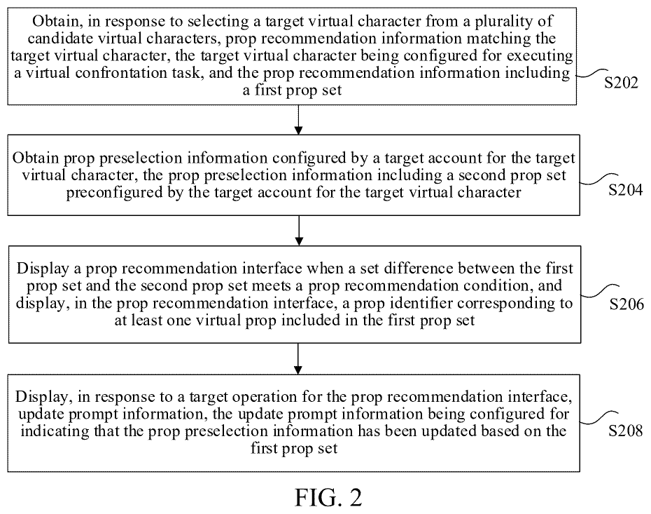

In some aspects, as shown in FIG. 2, the foregoing virtual prop recommendation method may be applied to a live client on which an anchor account is logged into, and includes the following operations:

S202: Obtain, in response to selecting a target virtual character from a plurality of candidate virtual characters, prop recommendation information matching the target virtual character, the target virtual character being configured for executing a virtual confrontation task, and the prop recommendation information including a first prop set. For example, based on a selection of a target virtual character from a plurality of candidate virtual characters, item recommendation information matching the target virtual character is obtained. The target virtual character is configured to perform a virtual task. The item recommendation information includes a first item set.

S204: Obtain prop preselection information configured by a target account for the target virtual character, the prop preselection information including a second prop set preconfigured by the target account for the target virtual character. For example, item preselection information of a target account for the target virtual character is obtained. The item preselection information includes a second item set preconfigured by the target account for the target virtual character.

S206: Display a prop recommendation interface when a set difference between the first prop set and the second prop set meets a prop recommendation condition, and display, in the prop recommendation interface, a prop identifier corresponding to at least one virtual prop included in the first prop set. For example, based on a set difference between the first item set and the second item set satisfying an item recommendation condition, a recommendation interface including set identifier information is output for display. In the recommendation interface, an item identifier corresponding to at least one virtual item included in the first item set is output for display.

S208: Display, in response to a target operation for the prop recommendation interface, update prompt information, the update prompt information being configured for indicating that the prop preselection information has been updated based on the first prop set. For example, based on a target operation performed on the recommendation interface, an update indication is output for display. The update indication indicates that the item preselection information is updated based on the first item set.

The foregoing implementation may be applied to a game application. In the game application, the target account may select the virtual character to control the virtual character to perform a confrontational operation in a virtual game scene, to complete the confrontation task. The foregoing confrontation task may be configured for indicating a confrontation task between virtual characters controlled by a real player. That is, in the foregoing confrontation task, the virtual characters may be divided into a plurality of object camps, so that a virtual object in another object camp is beaten by using a virtual interaction operation in a game, to obtain a win of the task. The virtual interaction operation may include, and is not limited to, one or more of an attack operation, a defense operation, a skill cast operation, and the like. The foregoing confrontation task may further be configured for indicating a confrontation task performed between a virtual character controlled by a real player and a virtual character controlled by an artificial intelligence (AI) player.

In operation S202, after the target virtual character is selected from the plurality of virtual characters, in a process in which the target account controls the target virtual character to complete the virtual confrontation task, different virtual props need to be obtained to enhance a virtual capability, like an attack capability, a movement capability, or a defense capability, of the target virtual character in the virtual confrontation task. Because different virtual props have different prop effects, when consumable virtual resources are definite, the target account needs to determine a to-be-obtained virtual prop in a process of controlling the target virtual character to complete the virtual confrontation task. When a large quantity of virtual props need to be obtained, the target account needs to determine an appropriate prop combination of virtual props, to improve a confrontation capability of the target virtual character in the confrontation task.

In addition, in some aspects, in a process of completing the virtual confrontation task, the target virtual character may choose to learn different confrontation skills, and then complete the virtual confrontation task by using a learned confrontation skill. In a process in which the target account controls the target virtual character to learn different virtual confrontational skills, various decisions need to be made. For example, when only one of two different virtual skills can be learned at a same moment, the target account needs to determine, from the two virtual skills, a virtual skill that the target virtual character currently needs to learn. Because skill effects of different virtual skills are different, correspondingly, target virtual characters learning different virtual skills may play different functions in the foregoing virtual confrontation task.

It can be learned that in a process in which the target account controls the target virtual character to complete the foregoing virtual confrontation task, a large quantity of decisions need to be made, for example, which virtual prop combination is obtained by using a same virtual resource, and which virtual skill is selected for the target virtual character at a same moment.

In operation S202, the first prop set included in the prop recommendation information is a combination of virtual props recommended for the target virtual character, indicating that the target account can obtain the virtual props in a particular order in the process of controlling the target virtual object to complete the virtual object task, to improve the virtual confrontation capability in the virtual confrontation task. In addition, in a process of the virtual confrontation task, when a quantity of virtual resources meets a prop acquisition condition, a strong reminding of the virtual props in the recommended prop set can be performed. In some aspects, the strong reminding can be achieved by highlighting the virtual props in the recommended prop set. For example, the virtual props in the recommended prop set can be displayed in a pop-up window interface, and the virtual props in the recommended prop set can also be enlarged, highlighted, superimposed with special effects, or the like. This can avoid that the target account makes temporary decisions on selection of props in a process of controlling the target virtual character to complete the virtual confrontation task, thereby improving efficiency of virtual prop selection.

In some aspects, the prop recommendation information may further include recommendation information about selection of various virtual skills of the target virtual character during the task, to avoid that the target account makes temporary decisions on the selection of skills in a process of controlling the target virtual character to complete the virtual confrontation task, thereby improving efficiency of virtual skill selection. There may be one or more pieces of prop recommendation information matching the target virtual character, and an amount of prop recommendation information is not limited in this aspect of this disclosure.

In some aspects, the obtaining prop recommendation information matching the target virtual character includes at least one of the following:

Manner 1: Obtain a plurality of pieces of fourth reference recommendation information matching the target virtual character, the fourth reference recommendation information including a seventh prop set; and determine the prop recommendation information from the plurality of pieces of fourth reference recommendation information based on a win rate parameter corresponding to each seventh prop set.

In Manner 1, the plurality of pieces of fourth reference recommendation information may be obtained first, and then the prop recommendation information may be determined based on the win rate parameter corresponding to the prop set included in each fourth reference recommendation information. The win rate parameter corresponding to the prop set refers to a probability of winning the virtual confrontation task when equipped with the virtual prop in the prop set. For example, the win rate parameter may be 80%, 50%, or the like. The plurality of pieces of fourth reference recommendation information may be a prop set related to the target virtual character and determined after statistics on operation records of a large quantity of players are collected, and respectively corresponding win rates may be counted based on different prop sets. In another example, prop recommendation information corresponding to a prop combination having a highest win rate may be obtained as the prop recommendation information to be recommended to the target virtual character.

In some aspects, a counting period of the win rate parameter may be determined based on an updated version of the confrontation task. When a version of the confrontation task is updated, confrontation strength of different virtual characters may change, and prop strength of each virtual prop may also change. Therefore, as an example, the counting period of the win rate parameter may be a period from a time stamp corresponding to a latest update operation of the confrontation task to a current time stamp, to determine a prop set corresponding to the highest win rate after the version update, and recommend a prop set corresponding to a highest win rate.

Manner 2: Obtain the prop recommendation information pushed by a teammate account, the teammate account being an object account having a same confrontational camp as the target account.

In Manner 2, the prop recommendation information may alternatively be prop recommendation information pushed by an object account having a same confrontational camp as the target account. Assuming that a current account corresponds to a novice player, and the teammate account is more familiar with the foregoing virtual confrontation task, a prop set more suitable for the target virtual character selected by the target account may be recommended for the current target account.

Manner 3: Obtain a historical operation record of the target account, the historical operation record including operation parameters of a plurality of virtual confrontation tasks completed by the target account controlling the target virtual character; and determine the prop recommendation information based on the operation parameters respectively corresponding to the plurality of virtual confrontation tasks.

In the third manner, the prop recommendation information may further be determined based on historical operation record of the target account. For example, a prop set most suitable for the target virtual character selected by the target account may be determined based on operation parameters (for example, parameters such as a quantity of defeats, a quantity of assists, and an amount of caused damage) respectively corresponding to a plurality of confrontation tasks completed by the target account in a target period, and is recommended.

The prop recommendation information determined in Manner 1, Manner 2, and Manner 3 may be presented simultaneously or partially. When a plurality of pieces of prop recommendation information are presented simultaneously, information sources of the foregoing prop recommendation information may be annotated.

Further, in operation S204, after the prop recommendation information is obtained, the prop preselection information configured by the target account for the target virtual character may be further obtained. The prop preselection information may be default prop recommendation information after the target account selects the target virtual character, and may include the second prop set preconfigured by the target account for the target virtual character. In some aspects, the prop preselection information may further include selection information of a virtual skill preconfigured by the target account for the target virtual character.

In some aspects, the prop preselection information may be prop recommendation information selected by the target account in a historical confrontation task; or may be prop recommendation information separately configured by the target account for the target virtual character; or may be a second prop set most frequently used when the target virtual character is selected by the target account in a historical confrontation task; or may be prop recommendation information generated based on the second prop set when the target account selects a second prop set formed by a plurality of target virtual props selected from a plurality of candidate virtual props in a current interface. In this aspect of this disclosure, a method for determining the prop preselection information is not limited.

Further, in operation S206, when the set difference between the second prop set indicated by the default prop recommendation information of the target virtual character, that is, the prop preselection information, and the first prop set meets the prop recommendation condition, the prop recommendation interface may be displayed, and the prop identifier corresponding to at least one virtual prop included in the first prop set is displayed in the prop recommendation interface, to quickly present the recommended virtual prop, so that a player quickly determines whether to use the first prop set indicated by the prop recommendation information. The set difference between the second prop set and the first prop set may be represented by at least one of a difference set between the first prop set and the second prop set, a difference between a first win rate parameter corresponding to the first prop set and a second win rate parameter corresponding to the second prop set, and a difference between a first confrontation parameter corresponding to the first prop set and a second confrontation parameter corresponding to the second prop set.

In some aspects, before displaying the prop recommendation interface when the set difference between the first prop set and the second prop set meets the prop recommendation condition, at least one of the following manners may be further included to determine whether the set difference between the first prop set and the second prop set meets the prop recommendation condition:

Manner 1: Determine, when a quantity of virtual props included in the difference set of the first prop set and the second prop set is greater than or equal to a target quantity, that the set difference between the first prop set and the second prop set meets the prop recommendation condition.

In this aspect of this disclosure, whether to present the prop recommendation interface may be determined based on a prop quantity of different virtual props in the first prop set and the second prop set. For example, when the prop quantity of different virtual props is greater than or equal to two, it may be considered that a difference between win rates respectively corresponding to the second prop set configured by the current target account and the preferred first prop set is greater than a threshold, and then the preferred first prop set may be recommended for presentation.

Manner 2: Determine, when the first win rate parameter corresponding to the first prop set is greater than the second win rate parameter corresponding to the second prop set, that the set difference between the first prop set and the second prop set meets the prop recommendation condition.

In this aspect of this disclosure, predicted win rates respectively corresponding to the first prop set and the second prop set may be compared by using a neural network model. When the first win rate parameter of the first prop set is greater than the second win rate parameter, the first prop set with a higher win rate is recommended for presentation.

Manner 3: Determine, when the first confrontation parameter corresponding to the first prop set is greater than the second confrontation parameter corresponding to the second prop set, that the set difference between the first prop set and the second prop set meets the prop recommendation condition, the first confrontation parameter being configured for indicating confrontation strength possessed by the target virtual character equipped with a virtual prop in the first prop set, and the second confrontation parameter being configured for indicating confrontation strength possessed by the target virtual character equipped with a virtual prop in the second prop set. The confrontation strength is a comprehensive indicator of fighting power and viability presented by the target virtual character in the virtual confrontation task.

In this aspect of this disclosure, predicted confrontation parameters respectively corresponding to the first prop set and the second prop set may be compared by using the neural network model. The confrontation parameter may include, and is not limited to, parameters such as a quantity of beats, a quantity of assists, and an accumulated damage value caused to an enemy virtual character. Then, when the first confrontation parameter corresponding to the first prop set and the second confrontation parameter corresponding to the second prop set are separately predicted, the first prop set having higher confrontation strength is recommended for presentation.

Further, the first prop set in the prop recommendation information may be accurately recommended by using the foregoing determining method for determining that the set difference between the first prop set and the second prop set meets the prop recommendation condition.

After the virtual prop in the first prop set is recommended in operation S206, as shown in operation S208, the update prompt information configured for indicating that the prop preselection information has been updated based on the first prop set is displayed in response to the target operation for the prop recommendation interface, thereby implementing one-click/tap switching of the preselected prop set.

According to the foregoing implementation of this disclosure, the prop recommendation information matching the target virtual character is obtained in response to selecting the target virtual character from the plurality of candidate virtual characters, the prop recommendation information including the first prop set; the prop preselection information configured by the target account for the target virtual character is obtained, the prop preselection information including the second prop set preconfigured by the target account for the target virtual character; when the set difference between the first prop set and the second prop set meets the prop recommendation condition, the prop recommendation interface is displayed and the prop identifier corresponding to at least one virtual prop included in the first prop set is displayed in the prop recommendation interface; and the update prompt information is displayed in response to the target operation for the prop recommendation interface, thereby achieving strong reminding of a better prop set in an interface in a process of preselecting a prop set, implementing quick switching of a preselected prop set in response to a one-click/tap operation on strong reminding information, and resolving a technical problem of low selection efficiency of a related virtual prop preselection method.

In some aspects, when the displaying a prop recommendation interface, and displaying, in the prop recommendation interface, a prop identifier corresponding to at least one virtual prop included in the first prop set is performed, the method further includes the following operations.

S1: Obtain recommendation description information included in the prop recommendation information, the recommendation description information being configured for indicating a set feature of the first prop set.

The set feature of the first prop set refers to an attribute or characteristic obtained by classifying, identifying, and distinguishing virtual props in the first prop set. These features can help a player or a system to identify and understand commonalities and features of these prop sets. The set feature includes, and is not limited to, a type feature, a quality feature, an attribute feature, a skill feature, and an appearance feature of the prop. A player can quickly identify and understand the virtual prop in the first prop set, and select and use a virtual prop according to a requirement of the player and a game policy by using the set feature.

S2: Display the recommendation description information in a display area associated with the prop recommendation interface.

When the prop identifier is presented in the prop recommendation interface, the recommendation description information may be further presented at the same time. The display area associated with the prop recommendation interface may include, and is not limited to, a display area in the prop recommendation interface, or a display area adjacent to or near the prop recommendation interface. In this implementation, a display position of the display area associated with the prop recommendation interface is not limited.

In some aspects, the displaying of the recommendation description information in the display area associated with the prop recommendation interface includes at least one of the following:

Manner 1: Display set identifier information of the first prop set in the display area associated with the prop recommendation interface, the set identifier information being configured for indicating a confrontation feature of the first prop set in the virtual confrontation task.

In this aspect of this disclosure, the set identifier information of the first prop set may be presented, and the set identifier information may be configured for indicating a confrontation feature of the first prop set in the confrontation task. The confrontation feature refers to an attribute and a function of the virtual prop in a confrontation environment. The confrontation feature may be an attacking type, a defensive type, a stealth type, a transient type, or the like. For example, when the virtual props included in the first prop set are mainly attacking-type virtual props, it may be determined that the set identifier information of the first prop set is an “attacking-type outfit”. When the virtual props included in the first prop set are mainly defensive-type virtual props, it may be determined that the set identifier information of the first prop set is a “defensive-type outfit”. The foregoing method for determining the set identifier information is merely an example, and is not intended to limit a manner of determining the set identifier information.

Manner 2: Display a target virtual path matching the first prop set in the display area associated with the prop recommendation interface, the target virtual path being a virtual travel path of the target virtual character in a process of executing the virtual confrontation task.

In various confrontation tasks, different virtual paths may include different enemy virtual characters and different virtual environments. Therefore, the prop set may further adapt to the target virtual path selected by the target virtual character. For example, for the target virtual character, when it is determined that the selected target virtual path is a first path, a most appropriate prop set corresponding to the path may be the first prop set. When it is determined that the selected target virtual path is a second path, a most appropriate prop set corresponding to the path may be the second prop set. When it is determined that the selected target virtual path is a third path, a most appropriate prop set corresponding to the path may be a third prop set. Further, the target virtual path to which the first prop set adapts is identified by using the foregoing implementation, thereby facilitating the player to determine whether the currently recommended first prop set matches a currently selected virtual path.

Manner 3: Display a set recommendation reason of the first prop set in the display area associated with the prop recommendation interface, the set recommendation reason being configured for indicating a comparison result of the first prop set and the second prop set.

In Manner 3, the recommendation reason of the first prop set may be further displayed. The recommendation reason may be determined based on the comparison result obtained through comparison with the second prop set. For example, recommendation may be an “outfit with a higher win rate”. Alternatively, recommendation may be an “outfit selected by most persons”. Alternatively, recommendation may be an “outfit highly recommended by a teammate AA”, to help a player improve selection efficiency in a preselection process of the prop set by using a simple reason description.

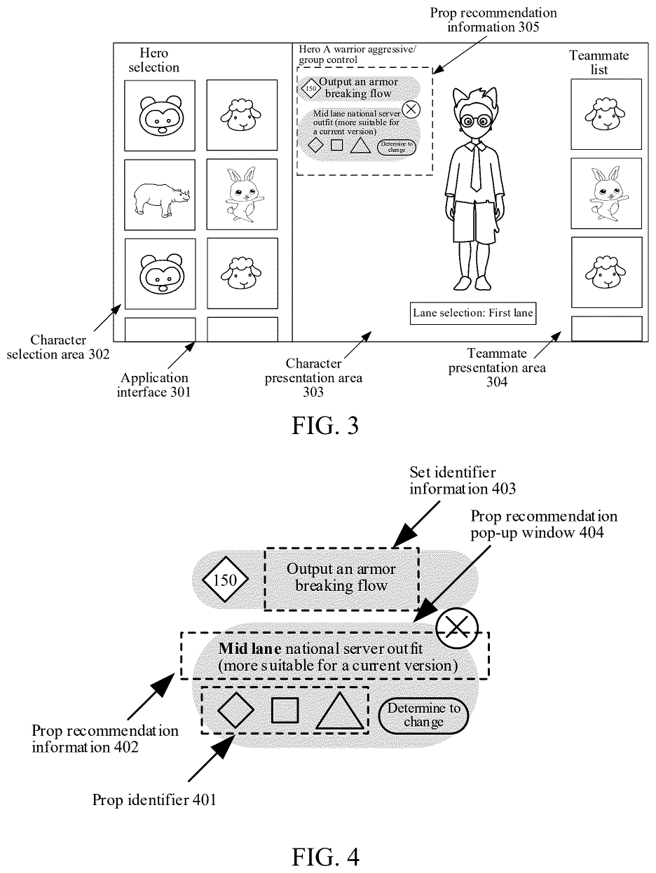

An implementation of this disclosure is described below with reference to FIG. 3 and FIG. 4.

As shown in FIG. 3, an application interface 301 is displayed at a task preparation stage of a target confrontation task. The application interface 301 includes a character selection area 302, a character presentation area 303, and a teammate presentation area 304. The character selection area 302 displays character identifiers respectively corresponding to a plurality of virtual characters, and a selected target virtual character may be determined in response to a selection operation on a target identifier in the character selection area 302. The selected virtual character is displayed in the character presentation area 303. In the teammate presentation area 304, character identifiers of virtual characters respectively selected by teammate accounts are displayed.

As shown in FIG. 3, in the character presentation area, when the current target virtual character is selected, and it is determined that a set difference between a first prop set and a second prop set meets a prop recommendation condition, prop recommendation information 305 may be displayed in the character presentation area 303. The prop recommendation information 305 includes a prop recommendation interface configured for displaying a prop identifier.

Content displayed by the prop recommendation information 305 may be shown in FIG. 4. As shown in FIG. 4, the recommendation information that may be displayed includes set identifier information 403 “Output an armor breaking flow”, and prop recommendation information 402 displayed in a prop recommendation interface 404, including a virtual path “mid lane” to which a current prop set adapts, a source “national server outfit” of the currently recommended prop set, and a recommendation reason “more suitable for a current version”. In addition, a prop identifier 401 of each virtual prop is further displayed in the prop recommendation interface 404.

According to the foregoing implementations of this disclosure, the recommendation description information included in the prop recommendation information is obtained, the recommendation description information being configured for indicating as the set feature of the first prop set. The recommendation description information is displayed in the display area associated with the prop recommendation interface, to quickly present the recommended prop set and various recommendation information in a form such as a pop-up window or a bubble, thereby improving decision-making efficiency of determining an appropriate prop set.

In some aspects, the displaying, in response to a target operation for the prop recommendation interface, update prompt information includes at least one of the following:

Manner 1: Highlight set identifier information in the recommendation description information based on a target animation.

In this aspect of this disclosure, the set identifier information may be highlighted based on the target animation, to prompt that replacement and update of a preselected prop set are completed currently.

Manner 2: Decorate and display the target virtual character displayed in the current interface based on at least one virtual prop included in the first prop set.

In this aspect of this disclosure, a prop in a selected prop set may be presented on the virtual character, to prompt that replacement and update of a preselected prop set are completed currently.

Manner 3: Display an update prompt window, and display update prompt text in the update prompt window, the update prompt text being configured for indicating that prop preselection information has been updated based on the first prop set.

In this aspect of this disclosure, a prompt window may be displayed, so that the preselected prop set is updated in a form of text.

The update prompt information may be displayed in one or more of Manner 1 to Manner 3, and the prompt manner is not limited in this aspect of this disclosure.

In some aspects, before the update prompt information is presented, presentation of the prop recommendation information may be canceled.

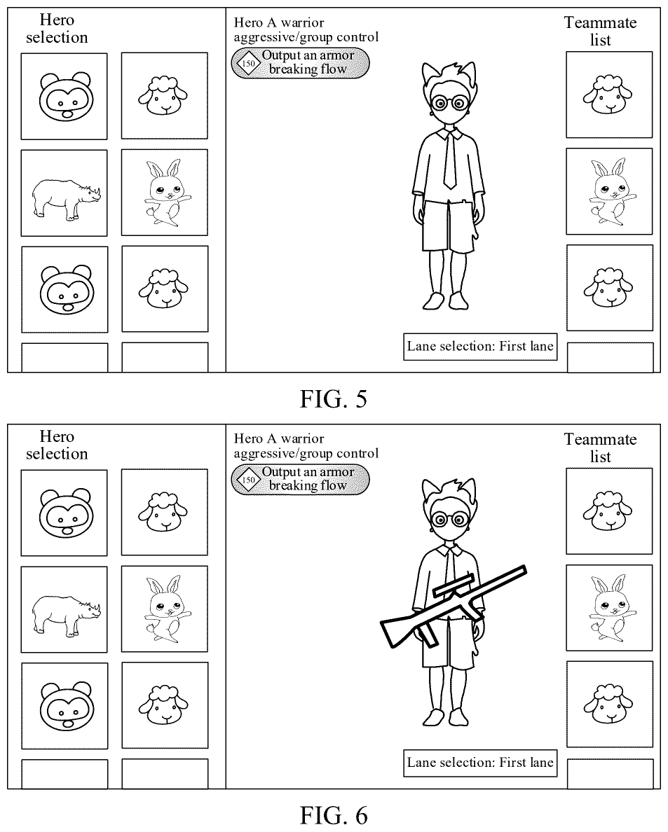

The following describes two prompt manners with reference to FIG. 3, FIG. 5, and FIG. 6.

In FIG. 3, when trigger of a determining control “Determine to replace” of the prop recommendation interface is detected, interface display is shown in FIG. 5. Display of the prop recommendation interface is canceled, and the set identification information is highlighted based on a preset target animation effect, to indicate that replacement of the preselected prop set is currently completed. The target animation effect may be a gradient animation effect, a fade-in and fade-out animation effect, a zoom animation effect, or the like.

In some aspects, as shown in FIG. 6, in addition to canceling display of the prop recommendation interface, and highlighting the set identification information based on a gradient animation effect, the virtual character displayed in the interface may be decorated and displayed based on the preselected virtual prop, to prompt that replacement of the preselected prop set is currently completed. In some aspects, a virtual character may be equipped with a virtual prop at a preset part, to decorate and display the virtual character. For example, when the virtual prop is wrist protection equipment, a virtual character may be equipped with the virtual prop at a wrist, to decorate and display the virtual character.

In some aspects, the update prompt information is displayed in response to the target operation for the prop recommendation interface, so that quick presentation of the recommended prop set is performed by using the prop recommendation interface. In addition, quick replacement and selection of the recommended prop set may be implemented in response to the target operation for the prop recommendation interface, thereby improving virtual prop replacement efficiency.

In some aspects, after the displaying a prop recommendation interface, and displaying, in the prop recommendation interface, a prop identifier corresponding to at least one virtual prop included in the first prop set, the method further includes: displaying, in response to a trigger operation for the prop identifier displayed in the prop recommendation interface, prop description information of the virtual prop corresponding to the prop identifier.

In a game, the prop description information of the virtual prop can provide related information about the virtual prop to a player, helping the player understand a purpose and an effect of the prop and how to use the prop in the game. The prop description information may include: a prop name, a prop picture, a prop type, a weight, and a volume, and may further include a use method, an effect generated when the prop is used, like increasing attack power or treatment, a use limitation (whether a specific condition is needed for use, like a level limitation or an occupation limitation), attack power/defense power that the prop can provide, an attribute bonus (for example, increasing character attributes such as strength, agility, and intelligence), a special effect, and the like.

Accurate and detailed prop description information not only can help a player make a better game decision, but also can improve depth and richness of a game.

In this aspect of this disclosure, in a process of recommending and presenting each prop identifier in the prop recommendation interface, corresponding prop description information may be further displayed in response to a selection operation for the prop identifier, so that when quick presentation of the recommended virtual prop is performed, more prop description information may be displayed through a further trigger operation or selection operation, thereby improving presentation efficiency of the prop information of the virtual prop.

In some aspects, after the displaying, in the prop recommendation interface, a prop identifier corresponding to at least one virtual prop included in the first prop set, the method further includes:

S1: Determine a target virtual prop based on the first prop set and the second prop set, the target virtual prop being a virtual prop that belongs to the first prop set but not to the second prop set.

S2: Highlight a target prop identifier of the target virtual prop.

In this aspect of this disclosure, a target virtual prop different from a virtual prop in the second prop set may be highlighted in the prop recommendation interface. Further, prop description information of the target virtual prop may be further displayed in response to a selection operation for a highlighted target prop identifier, for example, recommendation information, that is, a reason for newly adding a current target virtual prop is presented. For example, when the target prop identifier is selected, prop description information “A virtual damage value caused by the prop to an enemy virtual character in a current version is improved by 15%” may be displayed.

According to the foregoing implementation, quick presentation of a recommendation reason for recommending each virtual prop may be further performed, thereby improving decision-making efficiency of the preselected prop set.

In some aspects, after the displaying a prop recommendation interface, and displaying, in the prop recommendation interface, a prop identifier corresponding to at least one virtual prop included in the first prop set, the method further includes at least one of the following:

Manner 1: Cancel, in response to a touch operation for a cancel control in the prop recommendation interface, display of the prop recommendation interface.

Manner 2: Cancel display of the prop recommendation interface when a display duration of the prop recommendation interface is greater than or equal to a target duration.

Manner 1 and Manner 2 may be configured for canceling or rejecting preselection of the first prop set.

In some aspects, after the displaying a prop recommendation interface, and displaying, in the prop recommendation interface, a prop identifier corresponding to at least one virtual prop included in the first prop set, the method further includes at least one of the following:

Manner 1: Obtain, in response to a sliding operation for the prop recommendation interface, first reference recommendation information matching the target virtual character, the first reference recommendation information including a third prop set; and display, in the prop recommendation interface, a prop identifier corresponding to at least one virtual prop included in the third prop set.

In Manner 1, when a plurality of pieces of prop recommendation information are obtained, a next piece of prop recommendation information and a prop set included in the next piece of prop recommendation information are switched and displayed in response to the slide operation for the prop recommendation interface.

Manner 2: Obtain, in response to switching the target virtual character to a first virtual character, second reference recommendation information matching the first virtual character, the second reference recommendation information including a fourth prop set; obtain a fifth prop set preconfigured by the target account for the first virtual character; and display, in the prop recommendation interface when a set difference between the fourth prop set and the fifth prop set meets the prop recommendation condition, a prop identifier corresponding to at least one virtual prop included in the fourth prop set.

In this aspect of this disclosure, new prop recommendation information may be correspondingly obtained in response to a switching operation for the virtual character, and a prop set included in the newly obtained prop recommendation information is displayed.

Manner 3: Obtain, in response to switching a first virtual path of the target virtual character to a second virtual path, third reference recommendation information matching the second virtual path, the third reference recommendation information including a sixth prop set; and display, in the prop recommendation interface, a prop identifier corresponding to at least one virtual prop included in the sixth prop set.

In the foregoing implementation, different virtual paths correspond to different opponent virtual characters and virtual environments, so that in response to a switching operation for different virtual paths, different prop recommendation information may be correspondingly obtained through switching, and a prop set in prop recommendation information after the switching is displayed.

In some aspects, the determining the prop recommendation information from the plurality of pieces of fourth reference recommendation information based on a win rate parameter corresponding to each seventh prop set includes:

S1: Obtain a first character identifier of a teammate virtual character selected by the teammate account and a second character identifier of an opponent virtual character selected by an opponent account.

S2: Determine a virtual character combination corresponding to the virtual confrontation task based on the first character identifier and the second character identifier.

S3: Determine the win rate parameter corresponding to each seventh prop set based on the virtual character combination.

In this aspect of this disclosure, in a process of determining optimal prop recommendation information from the plurality of pieces of reference recommendation information, the teammate virtual character selected by the teammate account and the opponent virtual character selected by the opponent account may be further obtained, and when a current confrontation camp is determined, prop recommendation information most suitable for the target virtual character is determined based on the current confrontation camp.

In some aspects, after the obtaining prop recommendation information matching the target virtual character, the method further includes:

S1: Obtain, in response to a selection operation for an account identifier of a target teammate account in at least one teammate account, a teammate virtual character selected by the target teammate account.

S2: Push, in response to selecting target prop recommendation information from a plurality of pieces of prop recommendation information matching the teammate virtual character, the target prop recommendation information to the target teammate account.

In this aspect of this disclosure, the selected prop recommendation information may be recommended to the teammate accounts in response to the selection operation for the teammate account, to implement quick sharing and recommendation of prop recommendation information among different object accounts of a same camp.

In some aspects, after the displaying, in response to a target operation for the prop recommendation interface, update prompt information, the method further includes:

S1: Obtain, in response to a current confrontation parameter meeting a prop adjustment condition, prop adjustment information matching the current confrontation parameter in a process of executing the virtual confrontation task by using the first prop set by the target virtual character, the prop adjustment information including an eighth prop set.

S2: Display, in an application interface based on the prop adjustment information, a prop identifier of at least one virtual prop included in the eighth prop set.

S3: Update, in response to a selection operation for the prop adjustment information, the first prop set to the eighth prop set.

In this aspect of this disclosure, after the target account controls the target virtual character to enter the virtual confrontation task, a prop set most suitable for a current virtual confrontation situation may further be quickly determined based on a real-time confrontation situation, and a strong prompt is provided for the prop set most suitable for the current virtual confrontation situation, to improve replacement efficiency of replacing the preselected prop set by the target account in a battle process.

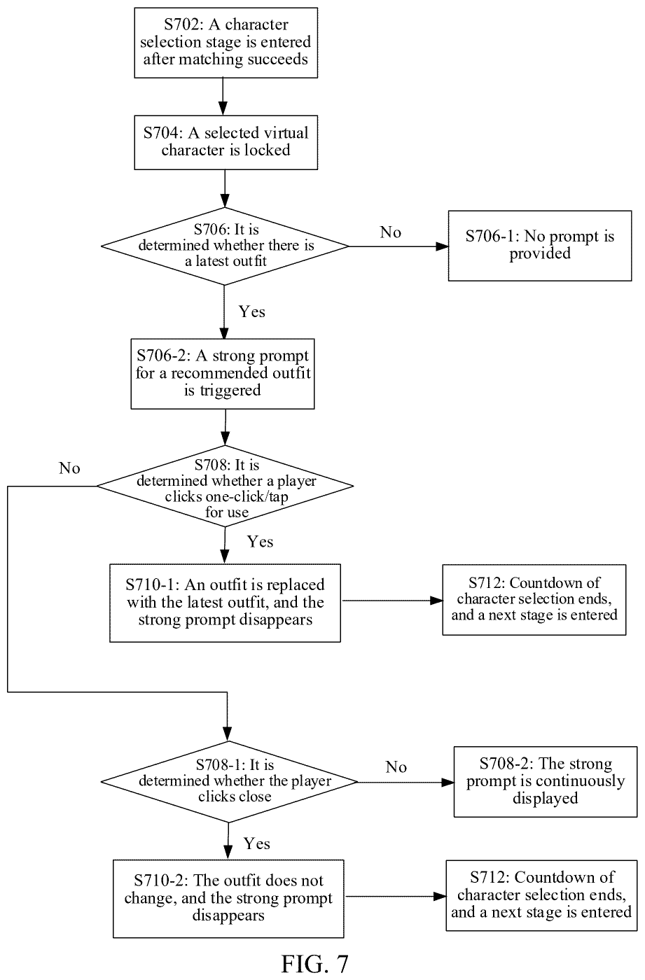

The following describes a complete process of this disclosure with reference to FIG. 7.

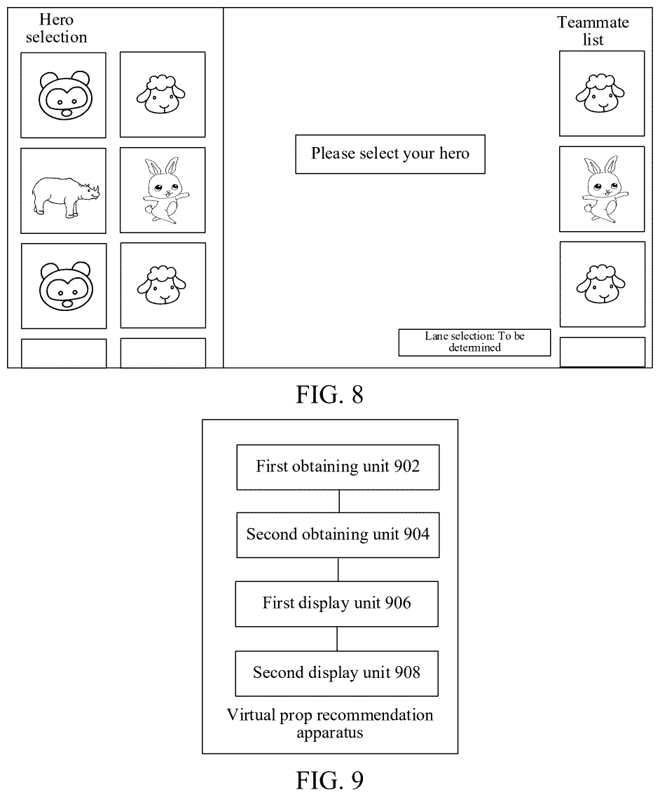

S702: A character selection stage is entered after matching succeeds. In some aspects, an interface of the character selection stage may be shown in FIG. 8, and a character selection prompt “Please select your hero” is displayed. In the character selection stage, a player may autonomously select a hero, and lock the hero.

S704: A selected virtual character is locked.

S706: It is determined whether there is a latest outfit. When there is no latest outfit, S706-1 is performed: No prompt is provided. When there is a latest outfit of the current virtual character, S706-2 is performed: A strong prompt for a recommended outfit is triggered.

In some aspects, after the hero is locked, a client determines whether to present a strong prompt bubble based on changes of equipment caused by great changes of the hero or great adjustment or update of equipment related to the hero. If a condition is met, the strong prompt bubble is presented, and if the condition is not met, there is no prompt. When the strong prompt bubble is presented, interface display is shown in FIG. 3.

S708: It is determined whether the player clicks one-click/tap for use. When the one-click/tap for use is clicked, S710-1 is performed: An outfit is replaced with the latest outfit, and the strong prompt disappears. Subsequently, S712 is performed: Countdown of character selection ends, and a next stage is entered.

The player may perform an operation on content in the bubble and click “Confirm replacement”, and the outfit may be replaced with the latest outfit. After receiving an operation feedback of the player, the client replaces the outfit of the player, presents a light scanning prompt at an entrance of the outfit, and closes the strong prompt bubble.

When One-click/tap for use is not clicked, S708-1 is performed: It is determined whether the player clicks Close. When Close is not clicked, S708-2 is performed: The strong prompt is continuously displayed. When Close is clicked, S710-2 is performed: The outfit does not change, and the strong prompt disappears. Next, S712 is performed: Countdown of character selection ends, and a next stage is entered.

In the foregoing operation, the player may click the “Close” button to close the current strong prompt bubble. After “Close” is clicked, the outfit is not changed, and the client receives an operation feedback of the player and closes the strong prompt bubble.

After the outfit is modified, other operations at the character selection stage may continue to be performed. A next stage is entered when the countdown of the character selection stage ends.

According to this aspect of this disclosure, a player may be prompted that there is a more suitable version of a solution to be selected. Through clear prompting and efficient replacement operations, a selection intention of the player is improved, thereby improving reasonableness of a player outfit solution, reducing cases in which the player uses an outfit solution of a lagging version, and optimizing battle experience of the player.

According to the foregoing implementation of this disclosure, the prop recommendation information matching the target virtual character is obtained in response to selecting the target virtual character from the plurality of candidate virtual characters, the prop recommendation information including the first prop set; the prop preselection information configured by the target account for the target virtual character is obtained, the prop preselection information including the second prop set preconfigured by the target account for the target virtual character; when the set difference between the first prop set and the second prop set meets the prop recommendation condition, the prop recommendation interface is displayed and the prop identifier corresponding to at least one virtual prop included in the first prop set is displayed in the prop recommendation interface; and the update prompt information is displayed in response to the target operation for the prop recommendation interface, thereby achieving strong reminding of a better prop set in an interface in a process of preselecting a prop set, implementing quick switching of a preselected prop set in response to a one-click/tap operation on strong reminding information, and resolving a technical problem of low selection efficiency of a related virtual prop preselection method.

For simple descriptions, the foregoing method aspects are stated as a series of action combinations. However, it is noted that this disclosure is not limited to the sequence of the described actions because according to this disclosure, some operations may use another sequence or may be simultaneously performed. In addition, a person skilled in the art is also to learn that the aspects described in this specification are example aspects, and the involved actions and modules are not necessarily required to this disclosure.

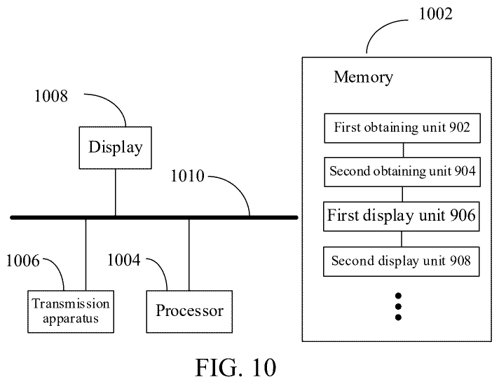

According to another aspect of aspects of this disclosure, a virtual prop recommendation apparatus for implementing the foregoing virtual prop recommendation method is further provided. As shown in FIG. 9, the apparatus includes: a first obtaining unit 902, configured to obtain, in response to selecting a target virtual character from a plurality of candidate virtual characters, prop recommendation information matching the target virtual character, the target virtual character being configured for executing a virtual confrontation task, and the prop recommendation information including a first prop set; a second obtaining unit 904, configured to obtain prop preselection information configured by a target account for the target virtual character, the prop preselection information including a second prop set preconfigured by the target account for the target virtual character; a first display unit 906, configured to display a prop recommendation interface when a set difference between the first prop set and the second prop set meets a prop recommendation condition, and display, in the prop recommendation interface, a prop identifier corresponding to at least one virtual prop included in the first prop set; and a second display unit 908, configured to display, in response to a target operation for the prop recommendation interface, update prompt information, the update prompt information being configured for indicating that the prop preselection information has been updated based on the first prop set.

In some aspects, the first display unit 906 includes: an obtaining module, configured to obtain recommendation description information included in the prop recommendation information, the recommendation description information being configured for indicating a set feature of the first prop set; and a display module, configured to display the recommendation description information in a display area associated with the prop recommendation interface.

In some aspects, the display module is configured to at least one of the following: display set identifier information of the first prop set in the display area associated with the prop recommendation interface, the set identifier information being configured for indicating a confrontation feature of the first prop set in the virtual confrontation task; display a target virtual path matching the first prop set in the display area associated with the prop recommendation interface, the target virtual path being a virtual travel path of the target virtual character in a process of completing the virtual confrontation task; and display a set recommendation reason of the first prop set in the display area associated with the prop recommendation interface, the set recommendation reason being configured for indicating a comparison result of the first prop set and the second prop set.

In some aspects, the second display unit 908 is configured to at least one of the following: highlight the set identifier information in the recommendation description information based on a target animation; decorate and display the target virtual character displayed in the current interface based on the at least one virtual prop included in the first prop set; and display an update prompt interface, and display update prompt text in the update prompt interface, the update prompt text being configured for indicating that the prop preselection information has been updated based on the first prop set.

In some aspects, the second obtaining unit 904 is further configured to at least one of the following: determine, when a quantity of virtual props included in a difference set of the first prop set and the second prop set is greater than or equal to a target quantity, that the set difference between the first prop set and the second prop set meets the prop recommendation condition; determine, when a first win rate parameter corresponding to the first prop set is greater than a second win rate parameter corresponding to the second prop set, that the set difference between the first prop set and the second prop set meets the prop recommendation condition; and determine, when a first confrontation parameter corresponding to the first prop set is greater than a second confrontation parameter corresponding to the second prop set, that the set difference between the first prop set and the second prop set meets the prop recommendation condition, the first confrontation parameter being configured for indicating predicted confrontation strength possessed by the target virtual character equipped with a virtual prop in the first prop set, and the second confrontation parameter being configured for indicating predicted confrontation strength possessed by the target virtual character equipped with a virtual prop in the second prop set.

In some aspects, the first display unit 906 is further configured to: display, in response to a trigger operation for the prop identifier displayed in the prop recommendation interface, prop description information of the virtual prop corresponding to the prop identifier.

In some aspects, the first display unit 906 is further configured to: determine a target virtual prop based on the first prop set and the second prop set, the target virtual prop being a virtual prop that belongs to the first prop set but not to the second prop set; and highlight a target prop identifier of the target virtual prop.

In some aspects, the virtual prop recommendation apparatus is further configured to at least one of the following: cancel, in response to a touch operation for a cancel control in the prop recommendation interface, display of the prop recommendation interface; and cancel display of the prop recommendation interface when a display duration of the prop recommendation interface is greater than or equal to a target duration.

In some aspects, the virtual prop recommendation apparatus further includes at least one of the following: a third display unit, configured to obtain, in response to a sliding operation for the prop recommendation interface, first reference recommendation information matching the target virtual character, the first reference recommendation information including a third prop set; a fourth display unit, configured to display, in the prop recommendation interface, a prop identifier corresponding to at least one virtual prop included in the third prop set; obtain, in response to switching the target virtual character to a first virtual character, second reference recommendation information matching the first virtual character, the second reference recommendation information including a fourth prop set; and obtain a fifth prop set preconfigured by the target account for the first virtual character; and a fifth display unit, configured to display, in the prop recommendation interface when a set difference between the fourth prop set and the fifth prop set meets the prop recommendation condition, a prop identifier corresponding to at least one virtual prop included in the fourth prop set; obtain, in response to switching a first virtual path of the target virtual character to a second virtual path, third reference recommendation information matching the second virtual path, the third reference recommendation information including a sixth prop set; and display, in the prop recommendation interface, a prop identifier corresponding to at least one virtual prop included in the sixth prop set.

In some aspects, the first obtaining unit 902 includes: a first obtaining module, configured to obtain a plurality of pieces of fourth reference recommendation information matching the target virtual character, the fourth reference recommendation information including a seventh prop set; and determine the prop recommendation information from the plurality of pieces of fourth reference recommendation information based on a win rate parameter corresponding to each seventh prop set; a second obtaining module, configured to obtain the prop recommendation information pushed by a teammate account, the teammate account being an object account having a same confrontational camp as the target account; and a third obtaining module, configured to obtain a historical operation record of the target account, the historical operation record including operation parameters of a plurality of virtual confrontation tasks completed by the target account controlling the target virtual character; and determine the prop recommendation information based on the operation parameters respectively corresponding to the plurality of virtual confrontation tasks.

In some aspects, the first obtaining module is configured to: obtain a first character identifier of a teammate virtual character selected by the teammate account and a second character identifier of an opponent virtual character selected by an opponent account; determine a virtual character combination corresponding to the virtual confrontation task based on the first character identifier and the second character identifier; and determine the win rate parameter corresponding to each seventh prop set based on the virtual character combination.

In some aspects, the second obtaining module is further configured to: obtain, in response to a selection operation for an account identifier of a target teammate account in at least one teammate account, a teammate virtual character selected by the target teammate account; and push, in response to selecting target prop recommendation information from a plurality of pieces of prop recommendation information matching the teammate virtual character, the target prop recommendation information to the target teammate account.

In some aspects, the virtual prop recommendation apparatus is further configured to: obtain, in a process of completing the virtual confrontation task based on the first prop set by the target virtual character and in response to a current confrontation parameter meeting a prop adjustment condition, prop adjustment information matching the current confrontation parameter, the prop adjustment information including an eighth prop set; display, in an application interface based on the prop adjustment information, a prop identifier of at least one virtual prop included in the eighth prop set; and update, in response to a selection operation for the prop adjustment information, the first prop set to the eighth prop set.

In some aspects, for aspects to be implemented by the foregoing unit modules, reference can be made to the foregoing method aspects.

According to still another aspect of aspects of this disclosure, an electronic device for implementing the foregoing virtual prop recommendation method is further provided. The electronic device may be a terminal device or a server as shown in FIG. 10. In this aspect of this disclosure, an example in which the electronic device is the terminal device is configured for description. As shown in FIG. 10, the electronic device includes a memory 1002 (an example of non-transitory computer-readable storage medium) and a processor 1004 (an example of processing circuitry). The memory 1002 has a computer program stored therein. The processor 1004 is configured to perform operations in any of the foregoing method aspects by using the computer program.

In some aspects, the foregoing electronic device may be located in at least one of a plurality of network devices in a computer network.

In some aspects, the foregoing processor may be configured to perform the following operations by using the computer program:

S1: Obtain, in response to selecting a target virtual character from a plurality of candidate virtual characters, prop recommendation information matching the target virtual character, the target virtual character being configured for executing a virtual confrontation task, and the prop recommendation information including a first prop set.

S2: Obtain prop preselection information configured by a target account for the target virtual character, the prop preselection information including a second prop set preconfigured by the target account for the target virtual character.

S3: Display a prop recommendation interface when a set difference between the first prop set and the second prop set meets a prop recommendation condition, and display, in the prop recommendation interface, a prop identifier corresponding to at least one virtual prop included in the first prop set.

S4: Display, in response to a target operation for the prop recommendation interface, update prompt information, the update prompt information being configured for indicating that the prop preselection information has been updated based on the first prop set.

In some aspects, a person of ordinary skill in the art may understand that a structure shown in FIG. 10 is only an example. The electronic device may alternatively be a terminal device such as a smartphone (such as an Android mobile phone or an iOS mobile phone), a tablet computer, a palmtop computer, a mobile internet device (MID), or a PAD. FIG. 10 does not constitute a limitation on a structure of the electronic device. For example, the electronic device may further include more or fewer components (for example, a network interface) than those shown in FIG. 10, or has a configuration different from that shown in FIG. 10.

The memory 1002 may be configured to store a software program and a module, for example, program instructions/modules corresponding to the virtual prop recommendation method and apparatus in the aspects of this disclosure. The processor 1004 runs the software program and the module stored in the memory 1002, to implement various functional applications and data processing, that is, implement the foregoing virtual prop recommendation method. The memory 1002 may include a high-speed random memory, and may also include a non-volatile memory, for example, one or more magnetic storage apparatuses, a flash memory, or another non-volatile solid-state memory. In some aspects, the memory 1002 may further include memories remotely disposed relative to the processor 1004, and the remote memories may be connected to a terminal through a network. Examples of the network include, and are not limited to, the internet, an intranet, a local area network, a mobile communication network, and a combination thereof. The memory 1002 may be specifically, and is not limited to, configured to store information such as various elements in a scene picture and virtual prop recommendation information. For an example, as shown in FIG. 10, the memory 1002 may include, and is not limited to, the first obtaining unit 902, the second obtaining unit 904, the first display unit 906, and the second display unit 908 in the foregoing virtual prop recommendation apparatus. In addition, the memory 1002 may further include, and is not limited to, another module unit in the foregoing virtual prop recommendation apparatus. This is not described again in this example.

In some aspects, the foregoing transmission apparatus 1006 is configured to receive or transmit data through a network. Specific instances of the foregoing network may include a wired network and a wireless network. In an example, the transmission apparatus 1006 includes a network interface controller (NIC). The NIC may be connected to another network device and a router by using a network cable, to communicate with the internet or a local area network. In an example, the transmission apparatus 1006 is a radio frequency (RF) module, and is configured to communicate with the internet in a wireless manner.

In addition, the electronic device further includes: a display 1008, configured to display a virtual scene in an interface; and a connection bus 1010, configured to connect various module components in the electronic device.

In other aspects, the terminal device or the server may be a node in a distributed system, where the distributed system may be a block-chain system. The block-chain system may be a distributed system formed by a plurality of nodes connected in the form of network communication. A peer to peer network may be formed between the nodes. Any form of a computing device, such as the server, the terminal, and another electronic device, may become a node in the block-chain system by joining the peer-to-peer network.

According to an aspect in this disclosure, a computer program product is provided. The computer program product includes a computer program/instructions. The computer program/instructions include program code configured for performing the method shown in the flowchart. In such an aspect, the computer program may be downloaded and installed from the network through a communication part, and/or may be installed from a removable medium. When the computer program is executed by a central processing unit, the computer program executes functions provided in the aspects of this disclosure.

The sequence numbers of the foregoing aspects of this disclosure are merely for description purpose and do not imply the preference among the aspects.

According to an aspect of this disclosure, a computer-readable storage medium, such as a non-transitory computer-readable storage medium is provided. A processor of a computer device reads computer instructions from the computer-readable storage medium. The processor executes the computer instructions, to cause the computer device to perform the foregoing virtual prop recommendation method.

In some aspects, the computer-readable storage medium may be configured to store a computer program configured for performing the following operations:

S1: Obtain, in response to selecting a target virtual character from a plurality of candidate virtual characters, prop recommendation information matching the target virtual character, the target virtual character being configured for executing a virtual confrontation task, and the prop recommendation information including a first prop set.

S2: Obtain prop preselection information configured by a target account for the target virtual character, the prop preselection information including a second prop set preconfigured by the target account for the target virtual character.

S3: Display a prop recommendation interface when a set difference between the first prop set and the second prop set meets a prop recommendation condition, and display, in the prop recommendation interface, a prop identifier corresponding to at least one virtual prop included in the first prop set.

S4: Display, in response to a target operation for the prop recommendation interface, update prompt information, the update prompt information being configured for indicating that the prop preselection information has been updated based on the first prop set.

In other aspects, the terminal device or the server may be a node in a distributed system, where the distributed system may be a block-chain system. The block-chain system may be a distributed system formed by a plurality of nodes connected in the form of network communication. A peer to peer network may be formed between the nodes. Any form of a computing device, such as the server, the terminal, and another electronic device, may become a node in the block-chain system by joining the peer-to-peer network.

In some aspects, a person of ordinary skill in the art may understand that all or some of the operations of various methods in the foregoing aspects may be implemented by a program instructing relevant hardware of a terminal device. The program may be stored in a computer-readable storage medium. The storage medium may include: a flash drive, a read-only memory (ROM), a random access memory (RAM), a magnetic disk, an optical disc, or the like.

When the integrated unit in the foregoing aspects is implemented in a form of a software functional unit and sold or used as an independent product, the integrated unit may be stored in the foregoing computer-readable storage medium. Based on such an understanding, the technical solutions of this disclosure may be implemented in a form of a software product. The computer software product is stored in a storage medium and includes several instructions for instructing one or more computer devices (which may be a PC, a server, a network device or the like) to perform all or some of operations of the methods in the aspects of this disclosure.

In the foregoing aspects of this disclosure, the descriptions of the aspects have respective focuses. For a part that is not described in detail in an aspect, reference can be made to related descriptions in other aspects.

In the several aspects provided in this disclosure, the disclosed client may be implemented in another manner. The foregoing described apparatus aspects are merely examples. For example, the unit division is merely logical function division and there may be other division manners in other implementations. For example, a plurality of units or components may be combined or integrated into another system, or some features may be omitted or not performed. In addition, the coupling, or direct coupling, or communication connection between the displayed or discussed components may be the indirect coupling or communication connection through some interfaces, units, or modules, and may be electrical or of other forms.

The units described as separate parts may or may not be physically separate, and components displayed as units may or may not be physical units, that is, may be located in one position, or may be distributed on a plurality of network units. Some or all of the units may be selected according to actual needs to achieve the objectives of the solutions of the aspects.

In addition, functional units in the aspects of this disclosure may be integrated into one processing unit, or each of the units may be physically separated, or two or more units may be integrated into one unit. The integrated unit may be implemented in a form of hardware, or may be implemented in a form of a software functional unit.

The foregoing descriptions are merely example implementations of this disclosure. Those of ordinary skill in the art may further make several improvements and modifications without departing from the principle of this disclosure, and the improvements and modifications fall within the scope of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A method for recommending virtual items, the method comprising:
obtaining, based on a selection of a target virtual character from a plurality of candidate virtual characters, item recommendation information matching the target virtual character, the target virtual character being configured to perform a virtual task, and the item recommendation information including a first item set;
obtaining item preselection information of a target account for the target virtual character, the item preselection information including a second item set preconfigured by the target account for the target virtual character;
outputting for display, based on a set difference between the first item set and the second item set satisfying an item recommendation condition, a recommendation interface including set identifier information;
outputting for display, in the recommendation interface, an item identifier corresponding to at least one virtual item included in the first item set; and
outputting for display, based on a target operation performed on the recommendation interface, an update indication, the update indication indicating that the item preselection information is updated based on the first item set.

2. The method according to claim 1, wherein
the first item set includes a first virtual prop set;
the second item set includes a second virtual prop set preconfigured by the target account; and
the at least one virtual item includes a virtual prop.

3. The method according to claim 1, further comprising:
obtaining recommendation description information included in the item recommendation information, the recommendation description information indicating a set feature of the first item set; and
outputting for display the recommendation description information in a display area associated with the recommendation interface.

4. The method according to claim 3, wherein the recommendation description information comprises at least one of:
set identifier information of the first item set in the display area, the set identifier information indicating a gameplay characteristic of the first item set in the virtual task;
a target virtual path matching the first item set in the display area, the target virtual path being a virtual travel path of the target virtual character during execution of the virtual task; and
a recommendation reason of the first item set in the display area, the recommendation reason indicating a comparison result between the first item set and the second item set.

5. The method according to claim 1, further comprising:
determining the set difference between the first item set and the second item set satisfies the item recommendation condition when at least one of:
a quantity of virtual items included in the set difference between the first item set and the second item set is greater than or equal to a target quantity;
a first win rate parameter corresponding to the first item set is greater than a second win rate parameter corresponding to the second item set; or
a first game state parameter corresponding to the first item set is greater than a second game state parameter corresponding to the second item set, the first game state parameter indicating gameplay effectiveness of the target virtual character equipped with the first item set, and the second game state parameter indicating gameplay effectiveness of the target virtual character equipped with the second item set.

6. The method according to claim 1, further comprising:
outputting for display, based on a trigger operation performed on the item identifier displayed in the recommendation interface, item description information of the virtual item corresponding to the item identifier.

7. The method according to claim 1, further comprising:
determining a differential virtual item based on the first item set and the second item set, the differential virtual item belonging to the first item set and not belonging to the second item set; and
identifying a differential item identifier of the differential virtual item.

8. The method according to claim 1, further comprising:
canceling display of the recommendation interface based on a touch operation performed on a cancel control element in the recommendation interface; or
canceling display of the recommendation interface when a display duration of the recommendation interface is greater than or equal to a target duration.

9. The method according to claim 1, further comprising:
obtaining, based on a sliding operation performed on the recommendation interface, first reference recommendation information matching the target virtual character, the first reference recommendation information including a third item set; and
outputting for display, in the recommendation interface, an item identifier corresponding to at least one virtual item included in the third item set.

10. The method according to claim 1, further comprising:
obtaining, based on switching the target virtual character to a first virtual character, second reference recommendation information matching the first virtual character, the second reference recommendation information including a fourth item set;
obtaining a fifth item set of the target account for the first virtual character; and
outputting for display, when a set difference between the fourth item set and the fifth item set satisfies the item recommendation condition, an item identifier corresponding to at least one virtual item included in the fourth item set.

11. The method according to claim 1, further comprising:
obtaining, based on switching a first virtual path of the target virtual character to a second virtual path, third reference recommendation information matching the second virtual path, the third reference recommendation information including a sixth item set; and
outputting for display, in the recommendation interface, an item identifier corresponding to at least one virtual item included in the sixth item set.

12. The method according to claim 1, wherein the obtaining the item recommendation information matching the target virtual character comprises at least one of:
determining the item recommendation information from fourth reference recommendation information matching the target virtual character, based on a win rate parameter corresponding to each of a plurality of seventh item sets included in the fourth reference recommendation information;
obtaining the item recommendation information pushed by a teammate account on a same team as the target account; or
obtaining the item recommendation information based on a historical operation record of the target account, the historical operation record including operation parameters of a plurality of virtual tasks completed by the target account that controls the target virtual character.

13. The method according to claim 12, wherein the determining the item recommendation information based on the win rate parameter comprises:
obtaining a first character identifier of a teammate virtual character selected by the teammate account and a second character identifier of an opponent virtual character selected by an opponent account;
determining a virtual character combination corresponding to the virtual task based on the first character identifier and the second character identifier; and
determining the win rate parameter corresponding to each of the seventh item sets based on the virtual character combination.

14. The method according to claim 1, further comprising:
obtaining, based on a selection operation performed on an account identifier of a target teammate account, a teammate virtual character selected by the target teammate account; and
pushing, based on a selection of target item recommendation information from a plurality of pieces of item recommendation information matching the teammate virtual character, the target item recommendation information to the target teammate account.

15. The method according to claim 1, further comprising:
obtaining, during execution of the virtual task based on the first item set by the target virtual character, and based on a current game state parameter meeting an item adjustment condition, item adjustment information matching the current game state parameter, the item adjustment information including an eighth item set;
outputting for display, in an application interface based on the item adjustment information, an item identifier corresponding to at least one virtual item included in the eighth item set; and
updating, based on a selection operation performed on the item adjustment information, the first item set to the eighth item set.

16. An apparatus for recommending virtual items, the apparatus comprising:
processing circuitry configured to:
obtain, based on a selection of a target virtual character from a plurality of candidate virtual characters, item recommendation information matching the target virtual character, the target virtual character being configured to perform a virtual task, and the item recommendation information including a first item set;
obtain item preselection information of a target account for the target virtual character, the item preselection information including a second item set preconfigured by the target account for the target virtual character;
output for display, based on a set difference between the first item set and the second item set satisfying an item recommendation condition, a recommendation interface including set identifier information;
output for display, in the recommendation interface, an item identifier corresponding to at least one virtual item included in the first item set; and
output for display, based on a target operation performed on the recommendation interface, an update indication, the update indication indicating that the item preselection information is updated based on the first item set.

17. The apparatus according to claim 16, wherein
the first item set includes a first virtual prop set;
the second item set includes a second virtual prop set preconfigured by the target account; and
the at least one virtual item includes a virtual prop.

18. The apparatus according to claim 16, wherein the processing circuitry is configured to:
obtain recommendation description information included in the item recommendation information, the recommendation description information indicating a set feature of the first item set; and
output for display the recommendation description information in a display area associated with the recommendation interface.

19. The apparatus according to claim 18, wherein the recommendation description information comprises at least one of:
set identifier information of the first item set in the display area, the set identifier information indicating a gameplay characteristic of the first item set in the virtual task;
a target virtual path matching the first item set in the display area, the target virtual path being a virtual travel path of the target virtual character during execution of the virtual task; and
a recommendation reason of the first item set in the display area, the recommendation reason indicating a comparison result between the first item set and the second item set.

20. A non-transitory computer-readable storage medium storing instructions which, when executed by a processor, cause the processor to perform:
obtaining, based on a selection of a target virtual character from a plurality of candidate virtual characters, item recommendation information matching the target virtual character, the target virtual character being configured to perform a virtual task, and the item recommendation information including a first item set;
obtaining item preselection information of a target account for the target virtual character, the item preselection information including a second item set preconfigured by the target account for the target virtual character;
outputting for display, based on a set difference between the first item set and the second item set satisfying an item recommendation condition, a recommendation interface including set identifier information;
outputting for display, in the recommendation interface, an item identifier corresponding to at least one virtual item included in the first item set; and
outputting for display, based on a target operation performed on the recommendation interface, an update indication, the update indication indicating that the item preselection information is updated based on the first item set.
